(19) United States
(12) Patent Application Publication
(10) Pub. No.: US 2026/0220112 A1
(43) Pub. Date: Jul. 30, 2026

(54) METHOD AND APPARATUS FOR COARSE CLUSTERING IN LSM STYLE TABLES

(71) Applicant: HUAWEI TECHNOLOGIES CO., LTD., Shenzhen (CN)

(72) Inventors: Saeed Soori, Toronto (CA); Robin GROSMAN, Markham (CA)

(73) Assignee: HUAWEI TECHNOLOGIES CO., LTD., Shenzhen (CN)

(21) Appl. No.: 19/041,394

(22) Filed: Jan. 30, 2025

(51) Int. Cl. G06F 16/22; G06F 16/28

(52) U.S. Cl. CPC G06F 16/2246; G06F 16/2264; G06F 16/285

(57) ABSTRACT

There is provided a method for multi-dimensional clustering on LSM-style tables. The method comprises selecting secondary keys over which the multi-dimensional clustering will occur, and selecting boundary ranges over the selected secondary keys. Runs on a given level may be merged together when they share a range over a secondary key, and the merged run is then stored on a lower level. When merging runs which intersect over a range of the primary key, only the intersecting portion is sorted.

### CROSS-REFERENCE TO RELATED APPLICATIONS

The present application is the first application in the first application for this disclosure.

### FIELD OF THE DISCLOSURE

The present disclosure relates to database management. Specifically, the present disclosure provides coarse clustering for database systems using Log-Structured Merge (LSM) trees.

### BACKGROUND

Analytic data systems employ different data layouts to improve the performance of filtering and scanning data in the storage layer. Typical approaches sort the data on a single column while advanced approaches use a combination of the columns or techniques such as z-ordering. It has been shown that accounting for multiple columns along with efficient index implementation can significantly improve the performance of scanning data.

### SUMMARY

It is an object of the present disclosure to provide an improved method for clustering data in systems using LSM trees.

According to a first aspect, there is provided a method for multi-dimensional clustering on a level of a Log-Structured Merge (LSM) tree, comprising: determining that the level is full; scanning a minimum index and a maximum index for a primary key and for secondary keys on the level; selecting range boundaries for the primary key and the secondary keys, wherein the range boundaries for the secondary keys comprise at least two ranges; and for each range of each of the secondary keys: selecting a set of runs from the level which are within the range; merging the runs in the set of runs to create an output run; tagging the output run with the range; and storing the output run on a lower level of the LSM tree.

According to an embodiment of the first aspect, said merging the runs comprises: finding an intersecting range over the primary key between the runs; and sorting the intersecting range over the primary key in the output run.

According to another embodiment of the first aspect, the range boundaries for the primary key define a single range.

According to yet another embodiment of the first aspect, the method further comprises repeating the method on the lower level of the LSM tree.

According to yet another embodiment of the first aspect, said selecting range boundaries creates ranges of equal size.

According to yet another embodiment of the first aspect, the method further comprises, prior to said determining that the level is full, determining that a size of the level is above a threshold size.

According to yet another embodiment of the first aspect, the method further comprises, prior to said scanning, determining a number of secondary keys.

According to yet another embodiment of the first aspect, the number of secondary keys is a function of a size of runs in the level.

According to yet another embodiment of the first aspect, the method further comprises selecting columns to serve as secondary keys based on the number of secondary keys.

According to yet another embodiment of the first aspect, columns are selected as secondary keys based on query statistics for each column.

According to a second aspect, there is provided a computing device comprising a processor and memory, wherein the computing device is configured to: determine that the level is full; scan a minimum index and a maximum index for a primary key and for secondary keys on the level; select range boundaries for the primary key and the secondary keys, wherein the range boundaries for the secondary keys comprise at least two ranges; and for each range of each of the secondary keys: select a set of runs from the level which are within the range; merge the runs in the set of runs to create an output run; tag the output run with the range; and store the output run on a lower level of the LSM tree.

According to an embodiment of the second aspect, said merging the runs comprises: finding an intersecting range over the primary key between the runs; and sorting the intersecting range over the primary key in the output run.

According to another embodiment of the second aspect, the range boundaries for the primary key define a single range.

According to yet another embodiment of the second aspect, the computing device is further configured to repeat the method on the lower level of the LSM tree.

According to yet another embodiment of the second aspect, said selecting range boundaries creates ranges of equal size.

According to yet another embodiment of the second aspect, the computing device is further configured to, prior to said determining that the level is full, determine that a size of the level is above a threshold size.

According to yet another embodiment of the second aspect, the computing device is further configured to, prior to said scanning, determine a number of secondary keys.

According to yet another embodiment of the second aspect, the number of secondary keys is a function of a size of runs in the level.

According to yet another embodiment of the second aspect, the computing device is further configured to select columns to serve as secondary keys based on the number of secondary keys, wherein columns are selected as secondary keys based on query statistics for each column.

According to a third aspect, there is provided a computer readable medium having stored thereon executable code for execution by a processor of a computing device, the executable code comprising instructions for: determining that the level is full; scanning a minimum index and a maximum index for a primary key and for secondary keys on the level; selecting range boundaries for the primary key and the secondary keys, wherein the range boundaries for the secondary keys comprise at least two ranges; and for each range of each of the secondary keys: selecting a set of runs from the level which are within the range; merging the runs in the set of runs to create an output run; tagging the output run with the range; and storing the output run on a lower level of the LSM tree.

### BRIEF DESCRIPTION OF THE DRAWINGS

FIG. 1 is an illustration of an LSM tree structure according to at least some embodiments of the present disclosure.

FIG. 2 is an illustration of the prior art additional column method for sorting data in runs.

FIG. 3A is an exemplary representation of runs stored at different levels of an LSM tree.

FIG. 3B is a graphical illustration of the ranges found in different runs.

FIG. 4 is a flow chart of a method for the compaction process according to at least some embodiments of the present disclosure.

FIG. 5A is a graphical illustration of an LSM tree to be compacted according to at least some embodiments of the present disclosure.

FIG. 5B is a cartesian illustration of the range of various runs in two columns, according to at least some embodiments of the present disclosure.

FIG. 6 is a block diagram of an exemplary computing device according to at least some embodiments of the present disclosure.

### DETAILED DESCRIPTION

The present disclosure provides an improved method for clustering data in systems using LSM trees.

Throughout the present disclosure, the following terminology will be followed.

Multi-dimensional clustering: a method of storing data by logically partitioning the data into blocks along multiple dimensions for faster access.

LSM tree: a data structure that maintains key-value pairs and stores the data in a sorted order. Data is stored in levels and once a level is full, it is flushed to a lower level which typically has a bigger size.

Run: Each level in LSM tree consists of multiple data blocks called runs. Typically, runs are sorted on a desired column.

Index: To gain faster access to data in a level, an index is defined on the runs. A typical example is keeping track of the range of a specific column of a run to improve filtering the data.

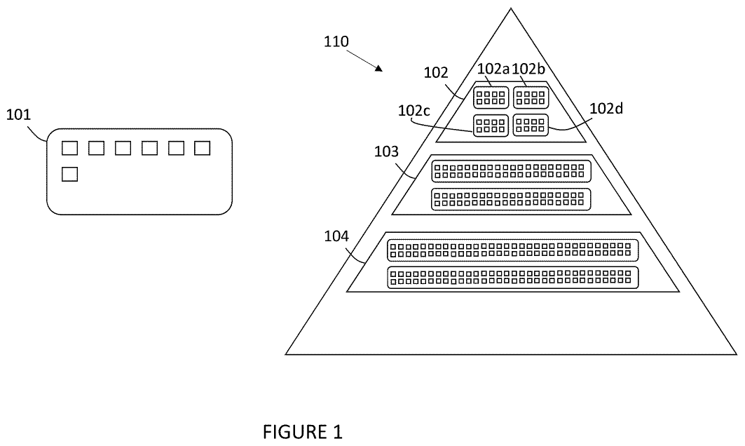

Reference is now made to FIG. 1 which shows a typical LSM tree storage.

As seen in FIG. 1, an LSM tree 110 comprises a plurality of levels, 102, 103, and 104, and a memory table 101. As will be appreciated, while three levels are shown, this is for exemplary purposes only and is not intended to be limiting.

When new data is received for storage in the LSM tree 110, it is initially stored in memory table 101. Memory table 101 is maintained in memory, as opposed to a disk, and is easily and rapidly accessible. Data in memory table 101 may be sorted based on a first key value, as it comes in. When memory table 101 is full, it is flushed to the disk, namely, to the first level 102.

Data stored in the levels of LSM tree 110, such as level 102, may be stored in runs, such as runs 102a, 102b, 102c, and 102d. Runs may be sorted, and combined with other runs, in a process called “compaction”. The compaction process may run in the background to periodically rearrange the data stored in the LSM tree. During compaction, data from a higher level may be pushed down to a lower level.

While LSM trees are designed for rapid write access, various strategies are known for improving read access.

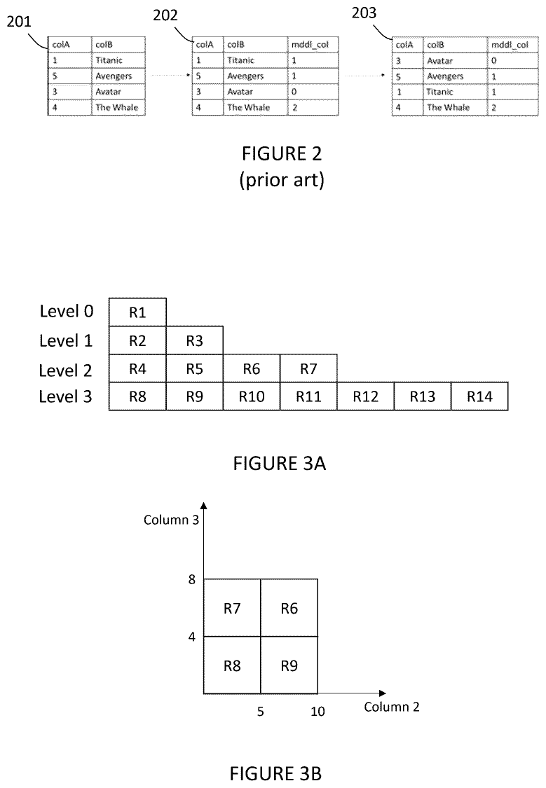

One such strategy, employed by Amazon Redshift™, is to add an extra column to tables, and to populate the column with entries that are representative of the entries in each other column, as illustrated in FIG. 2. As seen in FIG. 2, a first table 201 is unsorted, and comprises two columns, column A and column B.

Table 201 is then converted to table 202 which comprises an additional column. The additional column may comprise a value which is calculated based on the contents of the other columns. As an example, the additional column value may be incremented by 1 if the value in column A is greater than or equal to 4, and incremented by 0 if the value in column A is less than 4. Similarly, the additional column value may be incremented by 1 if the value in column B doesn't start with the letter ‘A’, and incremented by 0 otherwise. This produces table 202 which has values in the additional column of 1 (0 for column A, 1 for column B), 1 (1 for column A, 0 for column B), 0 (0 for column A, 0 for column B), and 2 (1 for column A, 1 for column B). Table 202 may then be sorted on the additional column to produce table 203.

With the data sorted as in table 203, it is now easier to locate entries within a given range.

Another strategy, termed “liquid clustering”, stores data in Z-cubes, which are data files in which data is sorted using Z-ordering, for sorting data on multiple columns. Upon receiving new data, any partial or incomplete z-cube is merged and sorted with the new data and a z-cube is generated.

Unfortunately, these prior art techniques do not support incremental clustering of newly ingested data. This leads to increased read times as new data is not stored with similar data, which causes longer search times.

Current approaches either repartition previously clustered data to incorporate newly ingested data or keep generating new clustered blocks without merging them. These approaches are costly and do not scale well in practice. Moreover, adding or removing columns require resorting the whole table which is not practical for large scale data.

In particular, for Amazon Redshift™, partitioning new data requires sorting the entire table. Moreover, for each workload, a separate partitioning is required to adapt to new queries. In Liquid Clustering, incremental clustering is not supported because it needs to re-apply z-ordering on new blocks and older data to create larger blocks. Furthermore, the z-cubes are not merged to generate bigger ones which will increase the cost of data scans.

The present disclosure introduces a new method, coarse clustering for LSM-style tables, which seeks to improve on prior art methods. Specifically, the approach introduced by the present disclosure seeks to provide the following benefits:
incremental clustering of newly ingested data using a tree structure in order to balance the cost of clustering and scan performance;
merging old clustered data with new data without the need for re-clustering the whole data;
enabling adding or removing columns without resorting the table.

These benefits are provided by a novel algorithm for the compaction of multiple runs in a level and spilling it to the level below. This new algorithm is characterized, in part, by the following features.

Adaptive column selection: Multi-Dimensional Clustering (MDC) chooses columns for partitioning based on statistics from previous levels and from queries. Each level may have a different number of columns to be partitioned. As a general rule, MDC prefers to partition on more columns for larger runs.

Multi-dimensional compaction: when a level is full, the compaction algorithm comprises the following steps:
Optimizing boundary selection: ranges of values stored in a run are selected to balance between the read operations for the primary key and range queries on secondary keys.
Partial compaction: if the runs to be compacted overlap, only the overlapping sections on the primary key are sorted and compacted on other dimensions. Otherwise, the sorting can be skipped.
Outputting multiple runs: unlike traditional LSM, MDC generates K>1 runs after a compaction. Each run belongs to a range chosen in the boundary selection step.

Reference is made to FIGS. 3A and 3B, which illustrate the benefit of MDC, according to at least some embodiments of the present disclosure.

Specifically, the MDC approach of the present disclosure improves efficiency in scanning and filtering data in storage systems. Accordingly, most online applications that process many queries at a large scale will benefit from MDC. Using incremental clustering on LSM can lead to 2× or greater improvement in I/O costs and faster query execution times.

As seen in FIG. 3A, an LSM tree is shown comprising levels 0-3, with runs R1 to R14, stored at different levels.

FIG. 3B shows the ranges for some of the runs shown in FIG. 3A.

Specifically, as seen in FIG. 3B, runs R6 and R7 comprise entries with column 3 values between 4 and 8, and runs R8 and R9 comprise entries with column 3 values between 0 and 4. Similarly, runs R7 and R8 comprise entries with column 2 values between 0 and 5, and runs R6 and R9 comprise entries with column 2 values between 5 and 10.

Assuming that the following query is received,
Select * from table where col2>5 and col3<4
   only entries from run R7 may be considered, as it is already known that entries from R6 do not satisfy col2<5, that entries from R8 do not satisfy col3>4, and that entries from R9 do not satisfy either.

Therefore, MDC improves read times by reducing the number of runs that are accessed to satisfy a query.

LSM tables comprise runs of increasing size. The present disclosure proposes a coarse clustering method that uses LSM and smart compaction, allowing for incremental data ingestion. Different clustering may be provided for smaller runs and larger runs. Moreover, a User-Defined Function (UDF) may be used on columns instead of a collection of columns.

According to at least some embodiments of the present disclosure, each run may be partitioned on selected columns. Runs may be sorted along a first selected column, and only overlapping blocks may be merged. The number of blocks and their boundaries may be adjusted during compaction.

According to at least some embodiments, longer runs may be partitioned on more columns compared to smaller runs. For example, the size of runs on the current level may be correlated to a number of columns to partition, and this correlation may be stored in a look-up table. When lower levels (i.e., levels 0 and 1) are small, the partitioning of these levels may be skipped to improve efficiency.

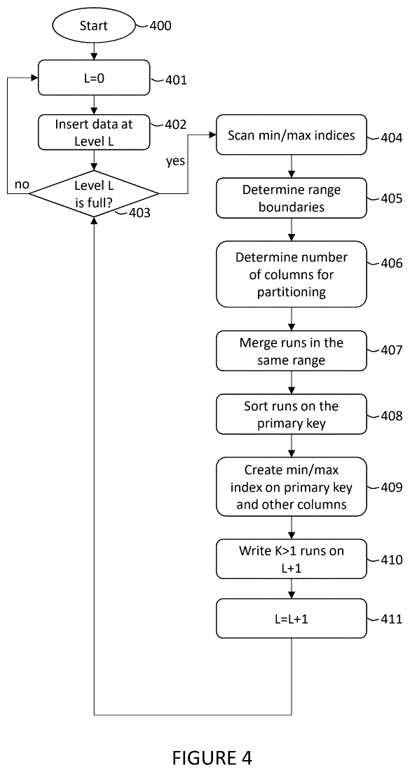

Reference is now made to FIG. 4 in which a compaction method according to at least some embodiments of the present disclosure is illustrated.

As seen in FIG. 4, the method starts at block 400 and proceeds to block 401 where the current level is set to level 0 (i.e., the top level, in which new data is inserted). The method then proceeds to block 402, where new data is inserted.

The method then proceeds to block 403, where a check is performed to see if the current level is full. If not, the method returns to block 402 to insert new data. If the current level (i.e., level 0) is full, the compaction process is initiated, and the method proceeds to block 404.

At block 404, the minimum and maximum values for the current level are read. These values represent the minimum value stored for the primary key and secondary keys on the current level, and the maximum value stored for the primary key and secondary keys on the current level. Within the context of the present disclosure, secondary keys are selected columns which are used to cluster data.

The method then proceeds to block 405, where the range boundaries are determined based on the minimum and maximum values read at block 404. In one embodiment, the range boundaries are determined to divide the data in equal sized runs.

The method then proceeds to block 406, where the number of columns for partitioning is determined. The columns for partitioning refer to the columns around which data will be clustered. The number of columns for partitioning may vary for different cases. In simple cases, the number of columns for partitioning may be two, but in more complex cases, the number may be larger. Generally, the columns selected for partitioning are the more relevant columns, such as the columns on which a large number of queries are run, columns with unique values for each entry, or any column which is considered to be particularly relevant.

The method then proceeds to block 407 where runs in the same range are merged. Specifically, the ranges are determined at block 405, and any runs in the current level which share a range over any partitioned column are merged. When runs sharing a range over a particular column are merged, and their range over the primary key intersects, only the intersecting portion needs to be resorted.

The method then proceeds to block 408 where the runs are sorted on the primary key.

The method then proceeds to block 409 where the runs are tagged with minimum and maximum values for the primary key and for other columns determined at block 406.

The method then proceeds to block 410 where the new runs are added to the level below the current level (and deleted from the current level). These new runs will have the ranges determined at block 405. The number of new runs created by this process is greater than 1, and depends on a number of factors such as the number of columns which are partitioned, and the minimum and maximum values for these columns within each run.

The method then proceeds to block 411 where the current level is set to the next level. The method then proceeds back to block 403 to determine if the current level is full. If yes, the compaction process is repeated, and if no, the method returns to block 401 where the current level is set to the first level, and new data is inserted at block 402.

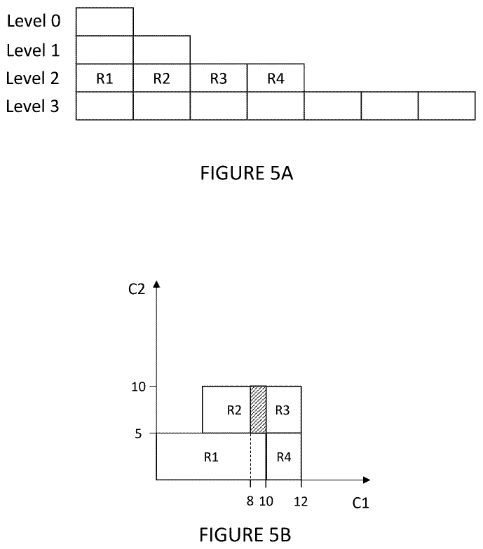

The above method will now be illustrated by way of example, with reference to FIG. 5A and FIG. 5B. For the purposes of this example, only the runs on level 2 will be compacted into level 3.

As seen in FIG. 5A, level 2 comprises 4 runs, namely R1, R2, R3, and R4. Furthermore, for the purpose of this example, only two columns will be considered, namely C1 and C2, and it shall be assumed that R1 has a range in C1 of 0-10, and range in C2 of 0-5, R2 has a range in C1 of 4-10, and a range in C2 of 5-10, R3 has a range in C1 of 8-12, and a range in C2 of 5-10, and R4 has a range in C1 of 10-12, and a range in C2 of 0-5.

FIG. 5B shows the runs R1, R2, R3, and R4 placed on a cartesian graph based on their respective ranges. Specifically, the horizontal axis represents C1, and the vertical axis represents C2. The area taken by each run represents their range in both C1 and C2. The darkened area represents where the ranges of R2 and R3 intersect.

Applying the method of FIG. 4, after finding that level 2 is full, at block 404, the minimum and maximum values are read. In this case, the minimum values for C1 is 0, and the maximum value is 12, while the minimum value for C2 is 0 and the maximum value is 10.

At block 405, the range boundaries are determined. In the present case, the range for C1 is 0-12, and the ranges for C2 are 0-5 and 5-10. As will be appreciated, this determination sets one range for C1 and 2 ranges for C2, implying that the runs created during compaction will cover the whole C1 range, and be split up between the two C2 ranges. In general, only one range is provided for the primary key, as all runs in LSM trees are sorted over the primary key. In this example, C1 is the primary key.

At block 406, the number of columns to be partitioned is determined. In this case, there are two columns that will be partitioned, namely C1 and C2. In other scenarios, more columns may be partitioned. For example, in cases where there are multiple secondary keys, either all the secondary keys are used as columns for partitioning, or a subset of the secondary keys are used as columns for partitioning. In at least some embodiments, the subset may be selected based on statistics such as the frequency of queries over each secondary key, or the number of runs in the current level that share a range (as determined at block 405) over each secondary key.

At block 407, runs that are in the same range are merged together. In this case, runs R1 and R4 share the range 0-5 in C2, and runs R2 and R3 share the range 5-10 in C2. Therefore, runs R1 and R4 are merged, and runs R2 and R3 are merged.

Notably, runs R2 and R3 have an overlapping range over C1. As the runs are merged, the overlapping range between R2 and R3 are sorted over C1. The non-overlapping sections of R2 and R3 are already sorted and do not need to be sorted further.

The merging of runs R1 and R4 produces run R1′, which is then stored in level 3, and the merging of runs R2 and R3 produces run R2′, which is also stored in level 3.

According to at least some embodiments, as new runs are produced, the runs are tagged with minimum values and maximum values for each partitioned column, and this information is used when queries for entries in a specific range are received, allowing the query to be processed by only searching relevant runs, and ignoring runs with values outside the range of the query.

Therefore, the present disclosure provides a novel method for compaction which allows for efficient partitioning of newly ingested data in the background, and provides a balance between query execution time and partitioning overhead. Moreover, the present disclosure provides a method which facilitates the addition of new partitioning columns for larger runs without the need to repartition the smaller runs, allows for the efficient running of a wider range of queries, and provides a bound on Input/Output cost and the number of loaded blocks.

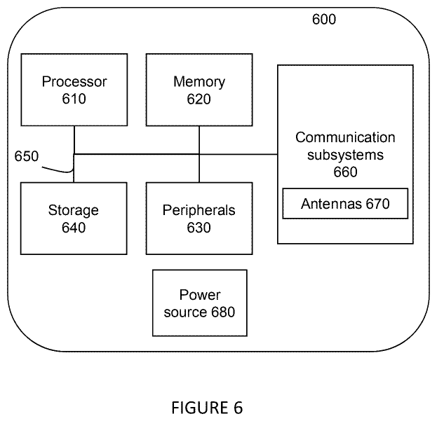

The above functionality may be implemented on any one or combination of computing devices. FIG. 6 is a block diagram of a computing device 600 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 600 may comprise a processor 610, memory 620, a mass storage device 640, and peripherals 630. Peripherals 630 may comprise, amongst others one or more input/output devices, such as a speaker, microphone, mouse, touchscreen, keypad, keyboard, printer, display, network interfaces, and the like. Communications between processor 610, memory 620, mass storage device 640, and peripherals 630 may occur through one or more buses 650.

The bus 650 may be one or more of any type of several bus architectures including a memory bus or memory controller, a peripheral bus, video bus, or the like. The processor 610 may comprise any type of electronic data processor. The memory 620 may comprise any type of system memory such as static random-access memory (SRAM), dynamic random-access memory (DRAM), synchronous DRAM (SDRAM), read-only memory (ROM), a combination thereof, or the like. In an embodiment, the memory 620 may include ROM for use at boot-up, and DRAM for program and data storage for use while executing programs.

The mass storage device 640 may comprise any type of storage device configured to store data, programs (e.g. instructions or code), and other information and to make the data, programs, and other information accessible via the bus. The mass storage device 640 may comprise, for example, one or more of a solid-state drive, hard disk drive, a magnetic disk drive, an optical disk drive, or the like. The memory 620 or mass storage 640 may store instructions, which when executed by a processor or processing unit, cause or configure the computing device 600 to perform any of the methods described herein.

Computing device 600 may further comprise a communications subsystem 660 for communicating with other computing devices or for connecting computing device 600 to a computer network. Communications subsystem 660 may comprise one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas 670 and one or more receivers/receive antennas 670. In an embodiment, the processing unit is coupled to a local-area network or a wide-area network, for data processing and communications with remote devices, such as other processing units, the Internet, remote storage facilities, or the like.

Computing device may further comprise a power source 680.

The present disclosure may be implemented on a computing device such as exemplary computing device 600. Computing device 600 may be a network element of a telecommunications network, such that the network element may be connected to other network elements of the telecommunication network, where all network elements form the telecommunication network. The network element may also receive communications from client devices connected to the telecommunication network and provide services to such client devices.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method for multi-dimensional clustering on a level of a Log-Structured Merge (LSM) tree, comprising:
determining that the level is full;
scanning a minimum index and a maximum index for a primary key and for secondary keys on the level;
selecting range boundaries for the primary key and the secondary keys, wherein the range boundaries for the secondary keys comprise at least two ranges; and
for each range of each of the secondary keys:
selecting a set of runs from the level which are within the range;
merging the runs in the set of runs to create an output run;
tagging the output run with the range; and
storing the output run on a lower level of the LSM tree.

2. The method of claim 1, wherein said merging the runs comprises:
finding an intersecting range over the primary key between the runs; and
sorting the intersecting range over the primary key in the output run.

3. The method of claim 1, wherein the range boundaries for the primary key define a single range.

4. The method of claim 1, further comprising repeating the method on the lower level of the LSM tree.

5. The method of claim 1, wherein said selecting range boundaries creates ranges of equal size.

6. The method of claim 1, further comprising, prior to said determining that the level is full, determining that a size of the level is above a threshold size.

7. The method of claim 1, further comprising, prior to said scanning, determining a number of secondary keys.

8. The method of claim 7, wherein the number of secondary keys is a function of a size of runs in the level.

9. The method of claim 7, further comprising selecting columns to serve as secondary keys based on the number of secondary keys.

10. The method of claim 9, wherein columns are selected as secondary keys based on query statistics for each column.

11. A computing device comprising:
a processor; and
memory;
wherein the computing device is configured to:
determine that the level is full;
scan a minimum index and a maximum index for a primary key and for secondary keys on the level;
select range boundaries for the primary key and the secondary keys, wherein the range boundaries for the secondary keys comprise at least two ranges; and
for each range of each of the secondary keys:
select a set of runs from the level which are within the range;
merge the runs in the set of runs to create an output run;
tag the output run with the range; and
store the output run on a lower level of the LSM tree.

12. The computing device of claim 11, wherein said merging the runs comprises:
finding an intersecting range over the primary key between the runs; and
sorting the intersecting range over the primary key in the output run.

13. The computing device of claim 11, wherein the range boundaries for the primary key define a single range.

14. The computing device of claim 11, further configured to repeat the method on the lower level of the LSM tree.

15. The computing device of claim 11, wherein said selecting range boundaries creates ranges of equal size.

16. The computing device of claim 11, further configured to prior to said determining that the level is full, determining that a size of the level is above a threshold size.

17. The computing device of claim 11, further configured to prior to said scanning, determine a number of secondary keys.

18. The computing device of claim 17, wherein the number of secondary keys is a function of a size of runs in the level.

19. The computing device of claim 17, further configured to select columns to serve as secondary keys based on the number of secondary keys, wherein columns are selected as secondary keys based on query statistics for each column.

20. A non-transitory computer readable medium having stored thereon executable code for execution by a processor of a computing device, the executable code comprising instructions for:
determining that the level is full;
scanning a minimum index and a maximum index for a primary key and for secondary keys on the level;
selecting range boundaries for the primary key and the secondary keys, wherein the range boundaries for the secondary keys comprise at least two ranges; and
for each range of each of the secondary keys:
selecting a set of runs from the level which are within the range;
merging the runs in the set of runs to create an output run;
tagging the output run with the range; and
storing the output run on a lower level of the LSM tree.
